(19) United States
(12) Patent Application Publication
(10) Pub. No.: US 2012/0293019 A1
(43) Pub. Date: Nov. 22, 2012

(54) CONNECTOR AND POWER FEEDING SYSTEM

(75) Inventors: Shigeru Tajima, Kanagawa (JP); Mario Tokoro, Tokyo (JP)

(73) Assignee: SONY CORPORATION, Tokyo (JP)

(21) Appl. No.: 13/519,335

(22) PCT Filed: Jan. 21, 2011
(86) PCT No.: PCT/JP2011/051092

§ 371 Date: Jun. 27, 2012

(30) Foreign Application Priority Data
Jan. 28, 2010 (JP) 2010-017360

(51) Int. Cl. H02G 3/02; H01R 13/04

(52) U.S. Cl. 307/147; 439/890

(57) ABSTRACT

A power feeding system which connects loads in series to receive a supply of power from a power source, and a connector which is suitable for use in the power feeding system are provided.

The connection and the power feeding system which receives a supply of a currents from a current source through the connector, and which has: connecting portions which are provided in series with respect to the current source, and to which a plug is detachably connected; and a first terminal and a second terminal which are connected with a conducting wire in which a current from the current source flows, which, when the plug is not connected to the connecting portion, contact each other to short-circuit the current from the current source, for which, when the plug is connected to the connecting portion, contact therebetween is released to flow the current from the current source to the plug, and which contact each other again when connection of the plug to the connecting portion is released to short-circuit the current from the current source.

### TECHNICAL FIELD

The present invention relates to a connector and a power feeding system.

### BACKGROUND ART

Recently, with an alternate current power distribution system of 100 V used at home, an input is a voltage power supply of a low impedance, and power from this voltage power supply is distributed in parallel using a pair of conducting wires. This alternate current system is very natural when a power source is a voltage source, and a fixed voltage is supplied to a load and a power value is determined by the current of the load.

Meanwhile, equipment and devices which are currently used are more suitably driven by a current than by a voltage. Typical devices and equipment which are suitably driven by a current include LEDs (Light Emitting Diodes). An LED literally means a diode, and is a constant voltage element. Hence, electric energy of an LED is controlled (that is, brightness is controlled) by increasing and decreasing a current instead of a terminal voltage. Further, white LEDs have been put into practical use, and use of LED lights is executed to expand in the future. To connect such an LED light to the current alternate current constant voltage system, a current is converted from the alternate current to the direct current inside a device, and the device then is driven by the constant current.

Further, currently, power transmission and distribution using the direct current is reexamined (for example, see Patent Literatures 1 and 2). Although, for example, superiority of direct current distribution will not be described below, it is obvious that direct current distribution is suitable for LED lights and the like for the above reason.

Hence, although a current supplying power distribution system which distributes the direct current is not necessarily effective for all electrical devices, the current supplying power distribution system is effective for devices of a certain current-driven type. With the current supplying power distribution system, a current source and loads are fundamentally connected in series, and power is increased and decreased by maintaining a fixed current, changing the voltage (of a supply source) according to the number of loads and adequately setting terminal voltages of loads.

### CITATION LIST

### Patent Literature

Patent Literature 1: JP 2001-306191

Patent Literature 2: JP 2008-123051

### SUMMARY OF INVENTION

### Technical Problem

The current supplying power distribution system and a voltage supplying power distribution system which distributes an alternate current are dual, and therefore are as follows upon comparison of some points.

First, while a power source is a voltage source with the voltage supplying power distribution system, a power source is a current source with the current supplying power distribution system. While a parameter of a fixed value is a voltage with the voltage supplying power distribution system, a parameter of a fixed value is a current with the current supplying power distribution system. While connection of loads is parallel connection with the voltage supplying power distribution system, connection of loads is serial connection with the current supplying power distribution system. Further, while connector electrodes are opened for the voltage at all times with the voltage supplying power distribution system, connector electrodes need to be closed for the current at all times with the current supplying power distribution system, and, while a switch is opened to power on a device switch with the voltage supplying power distribution system, a switch needs to be closed to power on a device switch with the current supplying power distribution system.

Thus, the voltage supplying power distribution system and the current supplying power distribution system have differences, and there is a problem that power cannot be supplied depending on connectors used by existing voltage supplying power distribution systems.

The present invention is made in light of the above problem, and therefore an object of the present invention is to provide a new and improved power feeding system which connect loads in series to receive a supply of power from a power source, and a new and improved connector which is suitable for use in the power feeding system.

### Solution to Problem

According to an aspect of the present invention in order to achieve the above-mentioned object, there is provided a connector including a connecting portion which is provided in series with respect to a current source, and to which a plug is detachably connected, and the connecting portion includes a first terminal and a second terminal which are connected with a conducting wire in which a current from the current source flows, which, when the plug is not connected to the connecting portion, contact each other to short-circuit the current from the current source, for which, when the plug is connected to the connecting portion, contact therebetween is released to flow the current from the current source to the plug, and which contact each other again when connection of the plug to the connecting portion is released to short-circuit the current from the current source.

The connector may further include a contact portion which prevents the plug from being detached when the plug is connected to the connecting portion, and which makes the first terminal and the second terminal contact when connection of the plug to the connecting portion is released.

With the connector, a plurality of pairs of the first terminal and the second terminal oriented differently with respect to the plug may be provided.

With the connector, a plurality of pairs of the first terminal and the second terminal having different lengths may be provided.

A direct current may be supplied from the current source.

Further, according to another aspect of the present invention in order to achieve the above-mentioned object, there is provided a power feeding system including: a current source which flows a current; a power receiving device which receives a supply of a current from the current source; a connector which supplies the current from the current source, to the power receiving device to which the connector is connected, and the power receiving device connects a plug to the connector to receive a supply of the current from the current source; the connector includes a connecting portion to which the plug is detachably connected, and the connecting portion includes a first terminal and a second terminal which are connected with a conducting wire in which a current from the current source flows, which, when the plug is not connected to the connecting portion, contact each other to short-circuit the current from the current source, for which, when the plug is connected to the connecting portion, contact therebetween is released to flow the current from the current source to the plug and then to the power receiving device, and which contact each other again when connection of the plug to the connecting portion is released to short-circuit the current from the current source.

The power receiving device and the current source may transmit and receive information to and from each other using the conducting wire.

With the power feeding system, a direct current may be supplied from the current source.

The power feeding system may further include a detachable current source which, when the current from the current source is supplied, connects to the connector to supplement a current, and the detachable current source may execute a switching operation of changing a voltage which is zero at a point of time when the detachable current source connects to the connector, to a predetermined voltage after a predetermined time passes after the connection.

### Advantageous Effects of Invention

As described above, according to the present invention, it is possible to provide a new and improved power feeding system which connects loads in series to receive a supply of power from a power source, and a new and improved connector which is suitable for use in the power feeding system.

### BRIEF DESCRIPTION OF DRAWINGS

FIG. 1 is an explanatory diagram illustrating a schematic configuration of a power feeding system 1 according to a first embodiment of the present invention.

FIG. 2 is an explanatory diagram illustrating an example of structures of a connector 20 and a plug 100.

FIG. 3 is an explanatory diagram illustrating process of connecting the plug 100 to the connector 20.

FIG. 4 is an explanatory diagram illustrating a configuration example of a current load 30 having a power switch.

FIG. 5 is an explanatory diagram illustrating another configuration example of a connector and a plug.

FIG. 6 is an explanatory diagram when a plug 100a illustrated in FIG. 5 is seen from the front.

FIG. 7 is an explanatory diagram illustrating another configuration example of a connector and a plug.

FIG. 8 is an explanatory diagram illustrating another configuration example of a connector and a plug.

FIG. 9 is an explanatory diagram illustrating another configuration example of a connector and a plug.

FIG. 10 is an explanatory diagram illustrating another configuration example of a connector and a plug.

FIG. 11 is an explanatory diagram illustrating an application example of the power feeding system 1.

FIG. 12 is an explanatory diagram illustrating a configuration of a power feeding system 2 according to a second embodiment of the present invention.

FIG. 13 is an explanatory diagram illustrating an example of a common constant current circuit.

FIG. 14 is an explanatory diagram illustrating an example where a circuit which increases a voltage without cutting a current is realized by a semiconductor.

FIG. 15 is an explanatory diagram illustrating a configuration of a power feeding system 3 according to a third embodiment of the present invention.

FIG. 16 is an explanatory diagram illustrating that a circuit unit including a voltage source 400 illustrated in FIG. 15 can be connected to the power feeding system 3 where necessary.

FIG. 17 is an explanatory diagram illustrating a configuration of an electrical vehicle 500 according to a fourth embodiment of the present invention.

### DESCRIPTION OF EMBODIMENTS

Hereinafter, preferred embodiments of the present invention will be described in detail with reference to the appended drawings. Note that, in this specification and the drawings, elements that have substantially the same function and structure are denoted with the same reference signs, and repeated explanation is omitted.

Descriptions will be made in the following order:

<1. First Embodiment>

[1-1. Configuration of Power Feeding System]

[1-2. Configuration Example of Connector and Plug]

[1-3. Application Example of Power Feeding System]

<2. Second Embodiment>

<3. Third Embodiment>

<4. Fourth Embodiment>

<5. Conclusion>

### 1. First Embodiment

[1-1. Configuration of Power Feeding System]

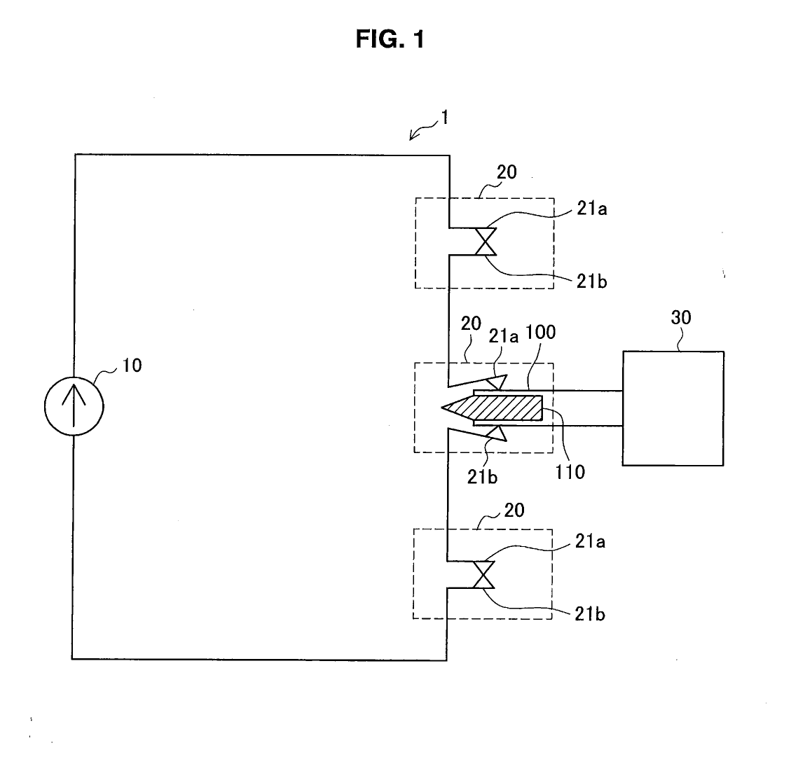

First, a configuration of a power feeding system according to a first embodiment of the present invention will be described with reference to the drawings. FIG. 1 is an explanatory diagram illustrating a schematic configuration of a power feeding system 1 according to the first embodiment of the present invention.

As illustrated in FIG. 1, the power feeding system 1 is configured to include a current source 10, connectors 20 and a current load 30. The current source 10 is a power source which outputs an alternate current or a direct current. In addition, it is practically preferable to output an alternate current from the current source 10 to configure the power feeding system 1 illustrated in FIG. 1.

The connector 20 connects the current load 30 to the power feeding system 1, and has a connecting portion in which a plug 100 is inserted. This connecting portion is configured to include electrodes 21a and 21b. The electrodes 21a and 21b are in a closed state when the current load 30 is not connected to the connector 20. This is different from a voltage supplying power distribution system which has electrodes in an opened state when a load (device) is not connected.

The current load 30 has the plug 100 for connecting to the power feeding system 1. By inserting the plug 100 in the connecting portion of the connector 20, the plug 100 contacts the electrodes 21a and 21b, and can receive power from the current source 10. In addition, the plug 100 is configured to include an insulating material 110 to prevent electrodes (not illustrated in FIG. 1) from being short-circuited.

When a plurality of loads is connected to the power supplying system 1, the loads are connected in series to the current source 10 as illustrated in FIG. 1. Preferably, the current source 10 uses a constant current source for performing controlling to provide a fixed current even when the number of loads connected to the power supplying system 1 increases or decreases.

[1-2. Configuration Example of Connector and Plug]

Next, structures of the connector 20 and the plug 100 will be described in detail.

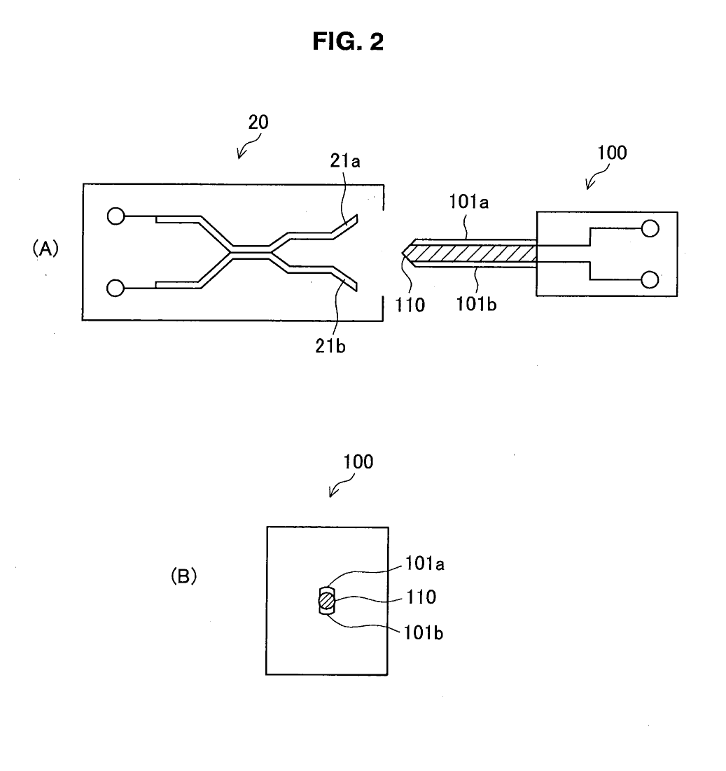

FIG. 2 is an explanatory diagram illustrating an example of structures of the connector 20 and the plug 100. FIG. 2(A) is an explanatory diagram illustrating a cross section of the example of the structures of the connector 20 and the plug 100. FIG. 2(B) is an explanatory diagram illustrating the plug 100 from the front. As illustrated in FIG. 2(A), the connector 20 is configured to include the electrodes 21a and 21b. Further, the plug 100 is configured to include electrodes 101a and 101b, and the insulating material 110 which prevents the electrodes 101a and 101 b from being short-circuited.

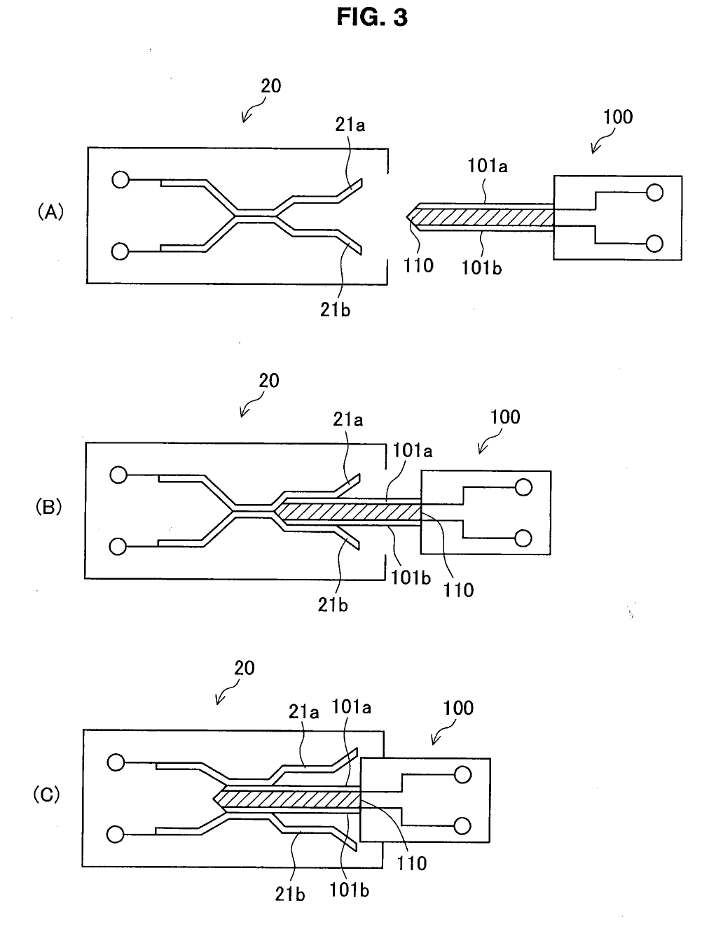

Process of connecting the plug 100 configured in this way to the connector 20 will be described. FIG. 3 is an explanatory diagram illustrating process of connecting the plug 100 illustrated in FIG. 2 to the connector 20. In addition, although not illustrated in FIG. 3, some load which requires a current from the current source 10 is connected to the plug 100.

FIG. 3(A) illustrates a state where the plug 100 is not connected to the connector 20. As illustrated in FIG. 3(A), in the state where the plug 100 is not connected to the connector 20, the electrodes 21a and 21b of the connector 20 are short-circuited.

FIG. 3(B) illustrates a state where the plug 100 is inserted halfway in the connector 20. As illustrated in FIG. 3(B), in the state where the plug 100 is inserted halfway in the connector 20, while the electrode 101a is connected to the electrode 21a and the electrode 101b is connected to the electrode 21b, the electrodes 21a and 21b are still short-circuited.

FIG. 3(C) illustrates a state where the plug 100 is completely inserted in the connector 20. As illustrated in FIG. 3(C), in the state where the plug 100 is completely inserted in the connector 20, the electrode 101a is connected to the electrode 21a and the electrode 101b is connected to the electrode 21b, and short-circuiting of the electrodes 21a and 21b is further released.

The connector 20 and the plug 100 are configured as illustrated in FIG. 2(A), so that it is possible to prevent instantaneous interruption of a current from the current source 10 in a current supply loop in the power feeding system 1, and connect the current load 30 to the power feeding system 1 or disconnect the current load 30 from the power feeding system 1. In addition, even if instantaneous interruption of a current from the current source 10 in the current supply loop in the power feeding system 1 does not matter, it is possible to simplify the structure of the electrodes of the connector.

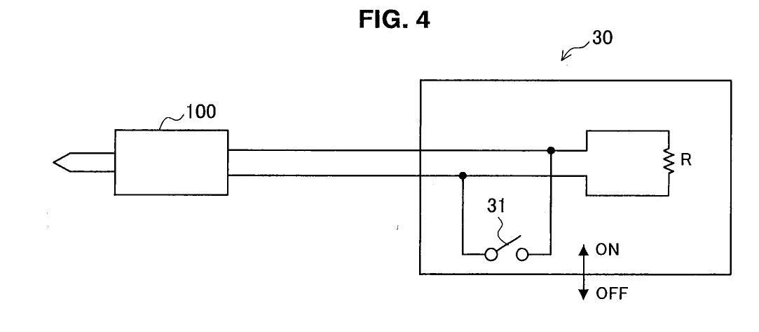

In addition, in some cases, a device to be connected to the power feeding system 1 requires a power switch for controlling reception of power supplied from the current source 10. FIG. 4 is an explanatory diagram illustrating a configuration example of the current load 30 having a power switch. The current load 30 illustrated in FIG. 4 has a power switch 31 for controlling reception of power supplied from the current source 10. As illustrated in FIG. 4, the power switch 31 blocks in the short-circuited state a supply of power supplied from the current source 10, to an interior of the current load 30, and supplies in the opened state a power supply from the current source 10, to the interior of the current load 30.

In addition, naturally, the configurations of the connector and the plug for connecting to the power feeding system 1 to receive a supply of power are by no means limited to the above. Hereinafter, another configuration example of a connector and a plug for connecting to the power feeding system 1 to receive a supply of power will be described.

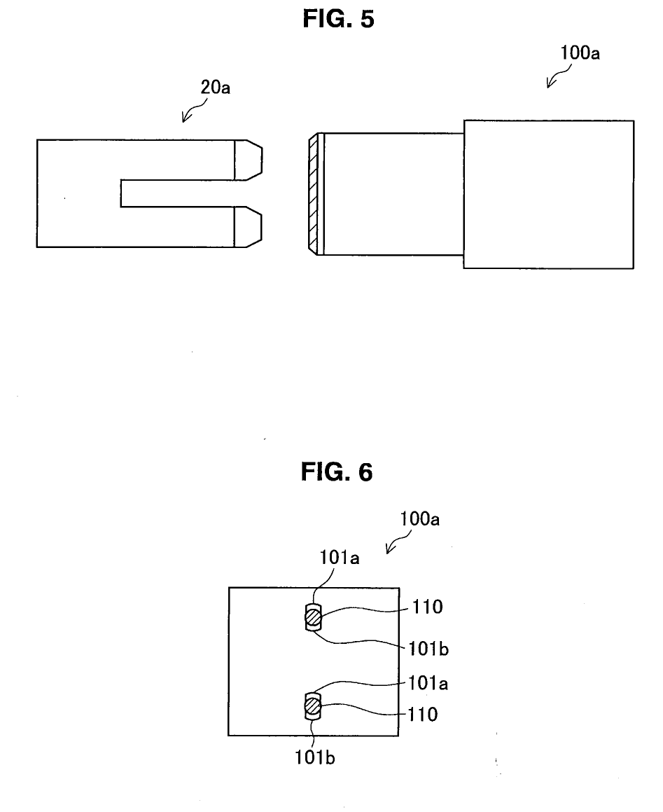

FIG. 5 is an explanatory diagram illustrating another configuration example of a connector and a plug for connecting to the power feeding system 1 to receive a supply of power. FIG. 5 illustrates a connector 20a and a plug 100a. With the configuration example of the connector and the plug illustrated in FIG. 5, the connector 20a which is a female side contact is divided multiply (into two with the example in FIG. 5), and the divided contacts are connected in parallel.

FIG. 6 is an explanatory diagram when the plug 100a illustrated in FIG. 5 is seen from the front. Thus, the plug 100a is configured to include two sets of electrodes 101a and 101b, and the insulating material 110 which prevents the electrodes 101a and 101b from being short-circuited.

Further, the connector 20a is configured to include the electrodes 21a and 21b as illustrated in FIG. 2(A), and is configured to include two sets of the electrodes 21a and 21b. When the plug 100a is not inserted, the electrodes 21a and 21b are short-circuited, and short-circuiting of the electrodes 21a and 21b is released when the plug 100a is inserted.

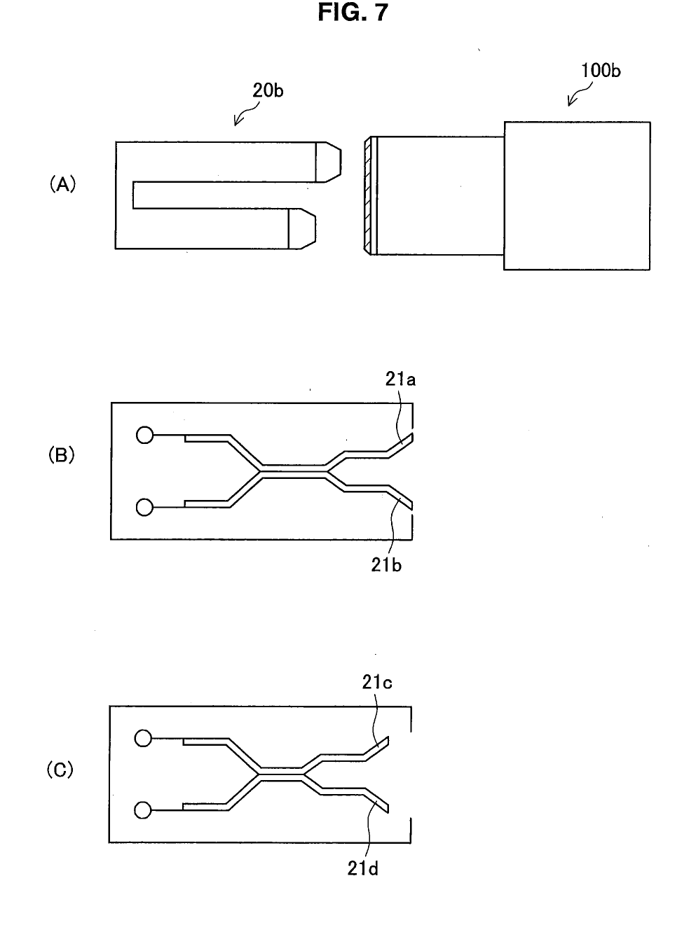

FIG. 7 is an explanatory diagram illustrating another configuration example of a connector and a plug for connecting to the power feeding system 1 to receive a supply of power. FIG. 7(A) illustrates a connector 20b and a plug 100b. With the configuration example of the connector and the plug illustrated in FIG. 7(A), the connector 20b which is a female side contact is divided multiply (into two with the example in FIG. 5), and the divided contacts are connected in parallel and the lengths of electrodes which are the female side contacts are further varied.

FIGS. 7(B) and 7(C) are explanatory diagrams illustrating a structure of electrodes provided inside the connector 20b. FIG. 7(B) illustrates electrodes 21a and 21b provided in an upper side of the connector 20b illustrated in FIG. 7(A), and FIG. 7(C) illustrates electrodes 21c and 21d provided in a lower side of the connector 20b illustrated in FIG. 7(A).

Thus, by providing the electrodes having different lengths inside the connector 20b, it is possible to mechanistically prevent instantaneous interruption of a current when the plug 100b is inserted in the connector 20b.

The connectors 20a and 20b illustrated in FIGS. 5 and 7 short-circuit the electrodes by means of a pressuring force produced by the elasticity of the electrodes. A configuration example of more efficiently short-circuiting these electrodes will be described.

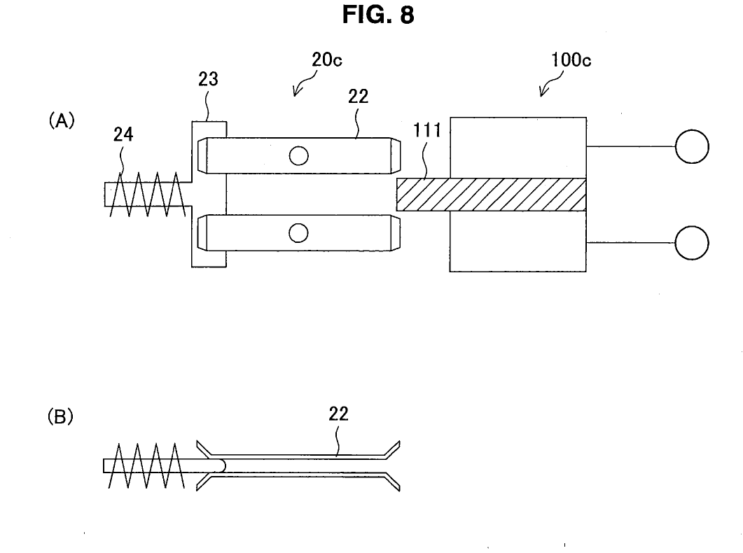

FIG. 8(A) is an explanatory diagram illustrating another configuration example of a connector and a plug for connecting to the power feeding system 1 to receive a supply of power. FIG. 8(A) illustrates a connector 20c and a plug 100c. Further, FIG. 8(B) is an explanatory diagram illustrating the cross section of an electrode 22 of the connector 20c illustrated in FIG. 8(A).

The plug 100c illustrated in FIG. 8(A) has a projection 111 made of an insulating material. This projection 111 functions to push out a short-circuiting contact 23 of the connector 20c. The connector 20c has a spring 24 for short-circuiting the electrodes when the plug 100c is pulled out. Preferably, the connector 20c or the plug 100c has a latch mechanism or a lock mechanism for canceling a recovering force of this spring 24.

In case of serial power feeding as in the power feeding system 1 illustrated in FIG. 1, a connector or a plug is preferably given the polarity.

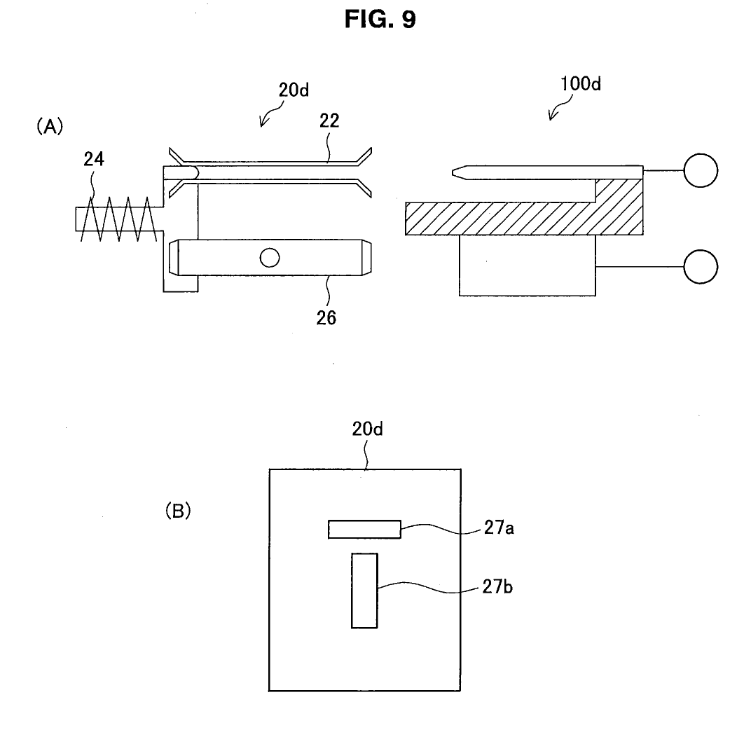

FIG. 9(A) is an explanatory diagram illustrating another configuration example of a connector and a plug for connecting to the power feeding system 1 to receive a supply of power. FIG. 9(A) illustrates a connector 20d and a plug 100d. FIG. 9(A) illustrates that the connector 20d is provided by rotating one electrode of the connector 20c in illustrated in FIG. 8(A) 90 degrees around a longitudinal direction, and the plug 100d is provided by rotating the other electrode likewise 90 degrees around the longitudinal direction accompanying rotation of one electrode.

FIG. 9(B) is an explanatory diagram illustrating an example of a shape of a cover of the connector 20d illustrated in FIG. 9(A), and illustrates the connector 20a seen from the front.

Consequently, it is possible to explicitly define the polarity by changing the orientation of one electrode. In addition, naturally, an arrangement of electrodes for explicitly defining the polarity is by no means limited to this example.

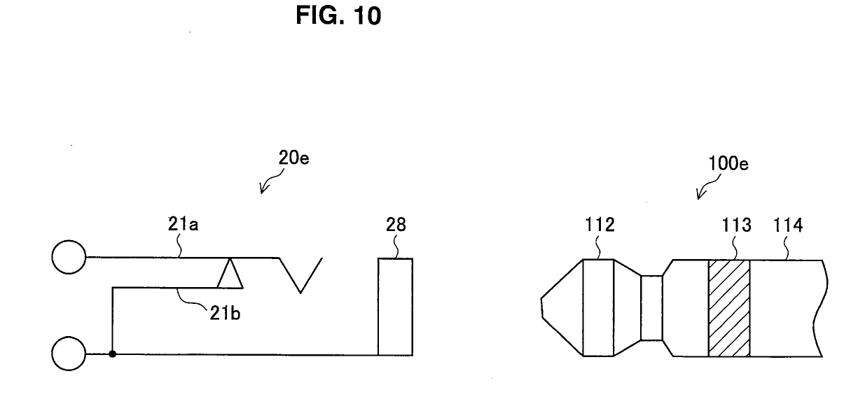

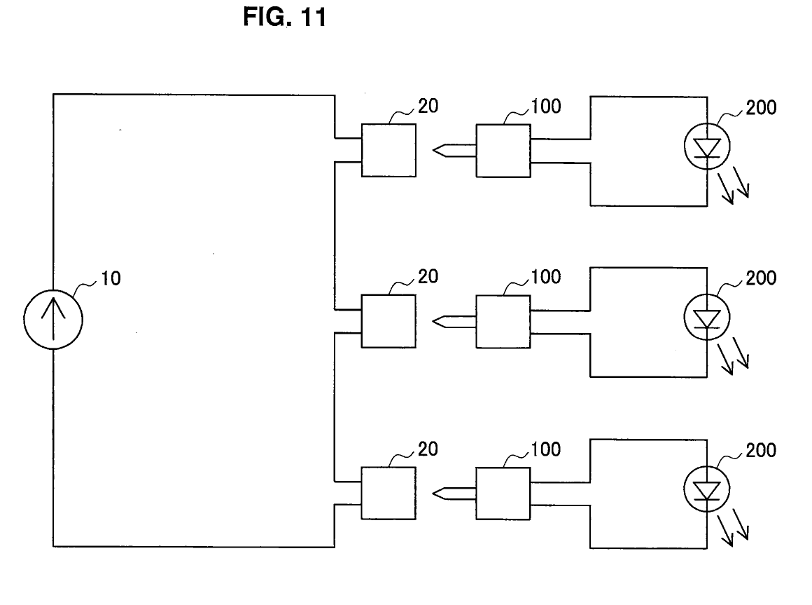

FIG. 10 is an explanatory diagram illustrating another configuration example of a connector and a plug for connecting to the power feeding system 1 to receive a supply of power. FIG. 10 illustrates a connector 20d and a plug 100d.

The connector 20d and the plug 100d illustrated in FIG. 10 are a jack with a switch and a plug which are conventionally used frequently for headphones and, by using a wiring of the connector 20d illustrated in FIG. 10 for a wiring of the jack, the jack can be used for a connector for serial power feeding.

When the plug 100d is not inserted in the connector 20d illustrated in FIG. 10, the electrode 21a and the electrode 21b are short-circuited. When the plug 100d is inserted in the connector 20d, short-circuiting of the electrode 21a and the electrode 21b is released, and an electrode 28 of the connector 20d conducts with an electrode 114 of the plug 100d. In addition, the plug 100d has a connecting portion 112 which is locked with the electrode 21 a when inserted in the connector 20d, and an insulating material 113 which is provided between the connecting portion 112 and the electrode 114 and which prevents the connecting portion 112 and the electrode 114 from being short-circuited.

With the connector 20d and the plug 100d illustrated in FIG. 10, the configurations can be made smaller, so that it is possible to provide effects of providing the polarity and a force of retaining the plug 100d by itself by means of the connecting portion 112 which is locked with the electrode 21a.

The configuration examples of the connector and the plug for connecting to the power feeding system 1 to receive a supply of power have been described. Next, a specific application example of the power feeding system 1 according to the first embodiment of the present invention will be described with reference to the drawings.

[1-3. Application Example of Power Feeding System]

FIG. 11 is an explanatory diagram illustrating an application example of the power feeding system 1 according to the first embodiment of the present invention. FIG. 11 illustrates the current source 10, the connectors 20, LED lights 200 which are current loads and the plugs 100 for connecting the LED lights 200 to the power feeding system 1. There are adequate numbers of LED lights 200, connectors 20 and plugs 100.

With the application example of the power feeding system 1 according to the first embodiment of the present invention illustrated in FIG. 11, a current value is set by the current source 10. Further, voltages at both ends of the LED light 200 are determined by the physical property of the LED, and are each about 2 to 4 V.

Consequently, even if a random number of LED lights 200 are connected or disconnected, currents flowing in the LED lights 200, and the brightness of the respective LED lights 200 do not change. Further, even if the number of LED lights 200 changes at random, excessive power is not supplied to a specific LED light 200.

In case where the power source of the power feeding system 1 according to the first embodiment of the present invention is a voltage source, the voltage of the voltage source needs to be substantially equal to a voltage determined by all LED lights 200 connected in series, and changing the number of LED lights 200 requires readjustment of the voltage every time the voltage is changed and is not realistic. Eventually, a constant current source needs to be set based on this voltage source.

Even when a unit is formed by connecting some LED lights 200 in series, (although the rated voltage of this unit changes), a random number of LEDs can be driven likewise with the same brightness. Naturally, when switches are connected to these LED units, the power switches 31 illustrated FIG. 4 can be provided.

The power feeding system 1 according to the first embodiment of the present invention illustrated in FIG. 11 is by no means limited to the application example, and, if the total of voltages of load terminals increases upon supply of a constant current, an output terminal voltage of the current source 10 is increased to maintain the property of the constant current. As a result, when the total of voltages exceeds a certain fixed voltage, the constant current can no longer be supplied and the current decreases. The same applied to the constant voltage supplying system, and, when the total current amount exceeds a defined value, the property of the constant voltage cannot be maintained any more.

Further, when all loads are opened (although this is an out-of-order state), a current loop is cut, and therefore an infinite voltage is produced to supply a constant current when the current loop is cut. Practically, it is preferable to determine a maximum value of the voltage, and prevent the voltage from rising more than this maximum value. This corresponds to limiting a maximum current value to supply a constant voltage in an existing power supply grid. Further, by varying the current value of the current source 10 and enabling user's control, it is possible to very simply control the brightness of lights.

### 2. Second Embodiment

The power supplying system which supplies power from the current source has been described with the above first embodiment of the present invention. As disclosed in, for example, above Patent Literature 2, there is a method of not only simply supplying power to loads which consume power, but also superimposing information and communicating about the loads. A case will be described with the second embodiment of the present invention where a main system is a current supply type, and communicates with the outside about loads.

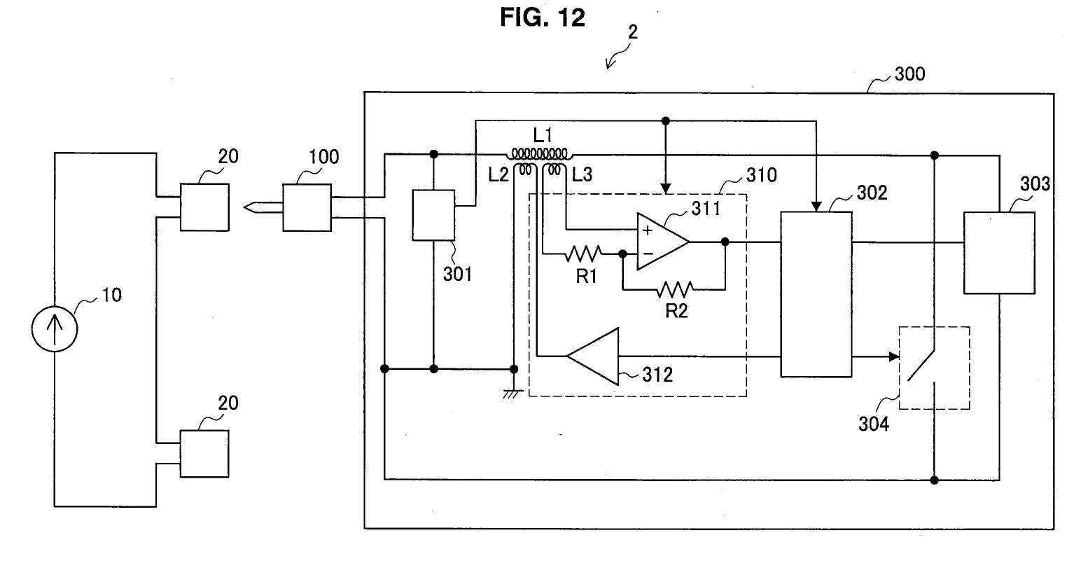

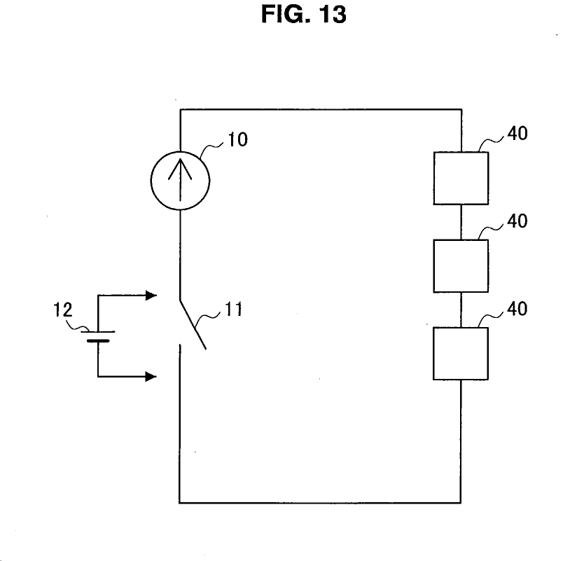

FIG. 12 is an explanatory diagram illustrating a configuration of a power feeding system 2 according to a second embodiment of the present invention. As illustrated in FIG. 12, the power feeding system 2 according to the second embodiment of the present invention has a current source 10, connectors 20, a current load 300 and a plug 100 for connecting the current load 300 to the power feeding system 2.

Further, the current load 300 has a converting circuit 301, a load control circuit 302, a load 303, a main switch 304, a communication circuit 310 and inductors L1, L2 and L3.

The converting circuit 301 has inside a battery for accumulating power to be supplied to each unit of the current load 300, and converts the current from the connector 100 (voltages produced at both ends) and supplies a power supply voltage to a circuit such as the load control circuit 302 or the communication circuit 310.

Although this converting circuit 301 is provided for a reason that, for example, a universal analog IC or a microprocessor which can be generally obtained at present is a voltage-driven type device, and a current-driven type device can also be fundamentally designed, no such a device is made at present and is lowly likely to appear in the future. Hence, the current load 300 according to the present embodiment supports a supply of a power source voltage to a voltage-driven type device which has this converting circuit 301. Further, the converting circuit 301 can be easily designed, and a power-saving (small current) voltage power source device such as the load control circuit 302 or the communication circuit 310 is developed, so that using these voltage devices is not inconvenient.

The load control circuit 302 executes various control of the load 303, and has a function of controlling the load 303 and communicating with the outside about the state of the load 303. The load 303 is a current-driven type load, and consumes power supplied from the battery 301 or the current source 10. The main switch 304 controls power supply to the load 303, does not supply power to the load 303 in a state where the main switch 304 is closed, and supplies power to the load 303 in a state where the main switch 304 is opened.

The communication circuit 310 enables communication through the conducting wire of the power feeding system 2, and is configured to include an operational amplifier 311, an amplifier 312 and resistances R1 and R2. The inductors L1, L2 and L3 are current-type coupling circuits, and are used for communication through the communication circuit 310. Although not illustrated in FIG. 12, the current source 10 also has the same communication function as the communication circuit 310, and, by executing communication between the current source 10 and the current load 300 connected at random, it is possible to control the state of the load 303 and report the state of the load 303 to the current source.

More specifically, the current load 300 executes negotiation with the current source 10 about supply content before opening the main switch 304 and supplying power to the load 303. For example, the load 303 is the current-driven type, and therefore the content to negotiate may be information about the voltage required by the load 303. When the negotiation is completed, the current source 10 starts supplying power to the current load 300. Hence, the load control circuit 302 preferably stores at least conditions and a standard upon start of an operation of the load 303. In addition, an actual negotiation protocol and a specific example of the negotiation protocol are disclosed in, for example, above Patent Literature 2, and therefore will not be described in detail.

### 3. Third Embodiment

A case has been described with the above second embodiment of the present invention where a main system is a current supply type, and communicates with an outside about a load.

Although cases have been described with each of the above embodiments where loads are connected in series, when the number of loads increases, a constant current is supplied to respective loads, and therefore a power source voltage on a supply side rises. Hence, when the number of loads increases, shortage of the power source voltage of a constant current device occurs. This corresponds to shortage of the current capacity in the constant voltage power source.

Meanwhile, in case of the constant current system, cutting the current is not basically desirable, and means for adjusting the voltage of the power source without cutting the current is desirable.

Hence, a power feeding system which can adjust the voltage of the power source without cutting the current will be described with the third embodiment of the present invention.

First, problems occurring when the voltage of the power source is adjusted without cutting the current in a common constant current circuit will be described. FIG. 13 is an explanatory diagram illustrating an example of a common constant current circuit. FIG. 13 illustrates the current source 10, a switch 11 and a plurality of (three in this case) loads 40.

With this constant current circuit, it is necessary to open the circuit once and insert the voltage source to connect the voltage source serially to the current source. When shortage of the voltage of the current source 10 occurs in a circuit in which, for example, the current source 10 and the loads 40 are connected as illustrated in FIG. 13, even if the voltage source 12 needs to be inserted in the circuit, the voltage source 12 cannot be inserted without turning off the serial switch 11 once. If the voltage source 12 is connected in a state where the switch 11 is in the on state, the voltage source 12 is short-circuited by the switch 11.

Hence, to increase the voltage without cutting the current upon power feeding based on the serial system, it is desirable to put in advance a circuit which can change the voltage which is zero to a predetermined voltage.

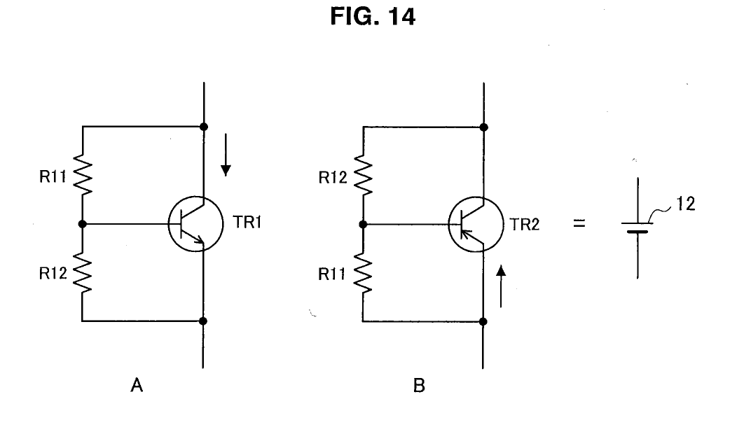

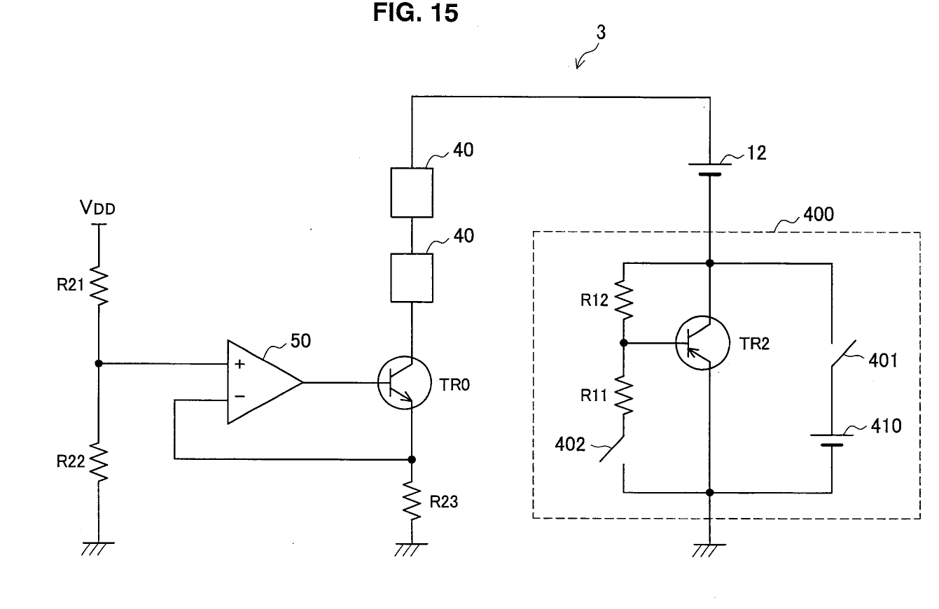

FIG. 14 is an explanatory diagram illustrating an example where such a circuit is realized by a semiconductor. For A in FIG. 14, an NPN transistor TR₁ and resistances R11 and R12 are used, and, for B in FIG. 14, a PNP transistor TR₂ and resistances R11 and R12 are used. Both of A and B can produce a voltage equivalent to the voltage source 12 by adequately selecting values of the resistances R11 and R12. In addition, arrows illustrated in FIG. 14 indicate orientations of currents. However, A and B in FIG. 14 do not voluntarily produce a voltage, have power sources outside, and seem to be the voltage source 12 when receiving a supply as indicated by the arrows. Further, when R12 is infinite in each circuit illustrated in FIG. 14, the transistors TR₁ and TR₂ seem to be diodes.

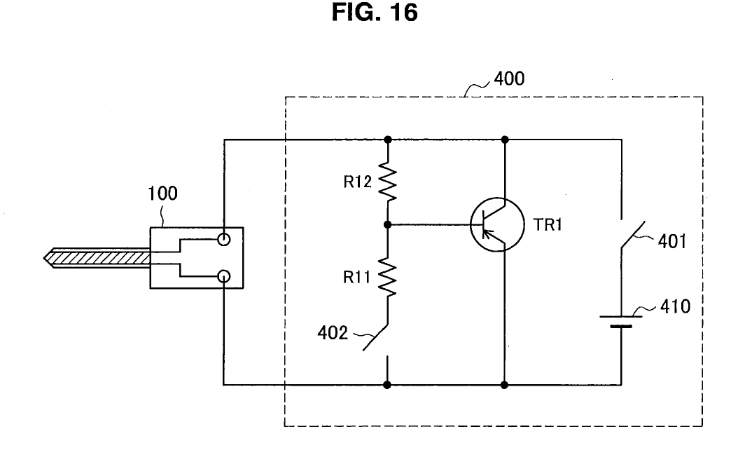

By using the circuit illustrated in this FIG. 14, it is possible to increase the voltage without cutting the current upon power feeding based on the serial system. FIG. 15 is an explanatory diagram illustrating a configuration of a power feeding system 3 according to a third embodiment of the present invention. As illustrated in FIG. 15, the power feeding system 3 according to the third embodiment of the present invention is configured to include the voltage source 12, the loads 40 and a constant current circuit including resistances R21, R22 and R23, a NPN transistor TR₀ and an operational amplifier 50.

In the power feeding system 3 illustrated in FIG. 15, when the number of loads 40 further increases or when consumption power of the loads 40 increases, shortage of the voltage of the voltage source 12 is likely to occur. Then, a method of connecting a new voltage source 400 without cutting a circuit will be described.

As illustrated in FIG. 15, the power source 400 is configured to include switches 401 and 402, a voltage source 410, a PNP transistor TR₂ and the resistances R11 and R12.

The switches 401 and 402 are in the opened state at first. When the switches 401 and 402 are in the opened state, the PNP transistor TR₂ simply seems to be a diode, and the voltage source 400 produces little voltage as a whole.

When the switch 402 is powered on in this state, the PNP transistor TR₂ operates as a circuit which has the same potential difference as the voltage source 410. When the switch 401 is then powered on, the voltage source 410 is validated. By turning off the switch 402 at last, this power feeding system 3 is connected with the voltage source 410. In addition, if the switch 402 is turned off at this time, reverse bias is applied to the PNP transistor TR₂ due to the voltage source 410, and the PNP transistor TR₂ does not seem to be a diode.

In addition, the power source 400 consumes a certain voltage in this operation, and therefore if shortage of the voltage of the load 40 and the like occurs, the property of a constant current cannot be maintained.

FIG. 16 is an explanatory diagram illustrating that a circuit unit including the voltage source 400 illustrated in FIG. 15 can be connected to the power feeding system 3 where necessary. The voltage source 400 has inside the switches 401 and 402, and places the switches 401 and 402 in the opened state before connecting to the power feeding system 3. The plug 100 for serial connection is prepared in this unit and, when connecting to the power feeding system 3, produces a potential difference corresponding to one diode at both ends of the plug 100. By turning on the switch 402 then, the potential difference at both ends of the plug 100 is a potential corresponding to the voltage source 410, and, by further turning on the switch 401, the actual voltage source 410 is connected to the power feeding system 3.

Hence, the voltage source 400 needs to connect to a connector (for example, the connector 20 illustrated in FIG. 1) and then sequentially perform control to open and close the switches 401 and 402. For example, a structure may be provided of inserting the plug 100 in a connector and then rotating the plug 100 to sequentially operate the switches 401 and 402.

### 4. Fourth Embodiment

An electrical vehicle having built-in driving motors in wheels requires at least two motors to drive the wheels. Four driving motors are required to drive front and rear wheels, and the number of driving motors changes according to the number of wheels which need to be driven.

In case of this in-wheel type driven electrical vehicle, if one of a pair of left and right wheels goes out of order and stops rotating, these wheels are likely to produce a significant influence in a traveling direction and cause danger. The simplest method of avoiding this influence is to connect main circuit connection wires of a pair of left and right wheel driving motors in series. Although the motors connected in series can be driven by a constant voltage or driven by a constant current, if a driving connection wire of at least one of the motors is cut, the driving forces for a pair of left and right wheels simultaneously disappear.

Upon driving using in-wheel motors, it is necessary to perform control to change the number of rotations of left and right wheels in order to change the traveling direction, and it is not possible to perform control to change this number of rotations when motors are simply connected in series. Hence, when brushless motors which have rotors such as magnets are used for motors in the left and right wheels, an auxiliary winding is prepared for a stator winding, and this current is adjusted to adjust the speeds of the left and right motors. Although this adjustment is required separately for the left and right wheels and therefore serial connection of motors is not principally suitable, the amount of adjustment is smaller than the current amount of the main connection wire.

Consequently, it is possible to control a difference between speeds of the left and right wheels (to some degree) while securing safety when main connection wires are connected in series and motor power lines are cut.

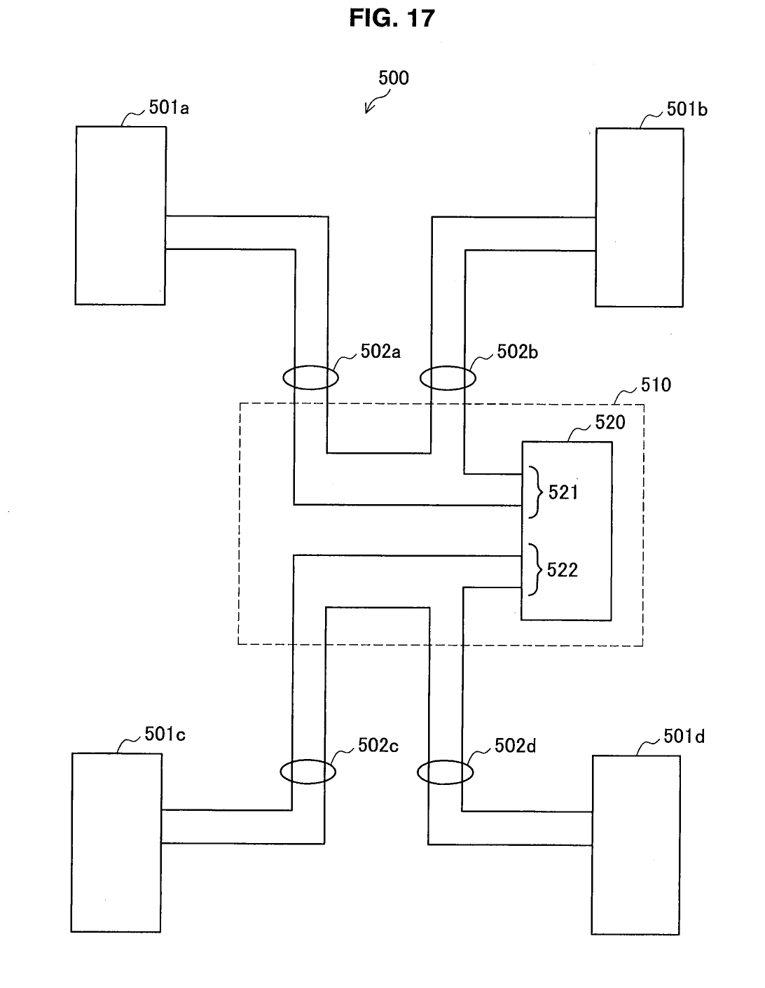

FIG. 17 is an explanatory diagram illustrating a configuration of an electrical vehicle 500 according to a fourth embodiment of the present invention. FIG. 17 illustrates connection wires between motors and a control circuit which take practicality into account.

In the electrical vehicle 500 illustrated in FIG. 17, front wheels 501a and 501b and rear wheels 501c and 501d are driven portions which form pairs of left and right wheels. Although motors are built in the front wheels 501a and 501b and the rear wheels 501c and 501d, respectively and three-phase brushless motors are practically used, the wheels will be driven by power supply DC motors of two wires for ease of description.

Power supply line 502a and 502b are associated with the front wheels 501a and 501b, respectively, and are connected in series inside a driving inverter 510. Further, power supply lines 502c and 502d are associated with the rear wheels 501c and 501d, respectively, and are connected in series inside the driving inverter 510. Naturally, although the supply lines may be connected in series outside the driving inverter 510, when practical connection wires are taken into account, it is better to design power lines from all driving units based on a common specification and it is efficient to connect the power lines as in the driving inverter 510 as illustrated in FIG. 17.

The driving inverter 5100 has a power outputting unit 520, and the power outputting unit 520 is configured to include a front wheel driving outputting unit 521 and a rear driving outputting unit 522. Only main driving portions are illustrated, and the front wheel driving outputting unit 521 and the rear wheel driving output unit 522 may be a voltage-driven type, a current-driven type or a combination of these. That is, whether the driving system of the front wheel driving outputting unit 521 and the rear wheel driving outputting unit 522 is the voltage-driven type or a current drive type does not matter.

With the electrical vehicle 500 illustrated in FIG. 17, even when one of the power supply lines 502a, 502b, 502c and 502d is cut, the driving force does not become unbalanced between the left and right wheels. Consequently, even when one of the power supply lines 502a, 502b, 502c and 502d is cut during running, steering does not become stable.

With the present embodiment, motors can be driven by either a constant voltage or a constant current, connection of the motors and the inverter is fundamentally permanent connection. Accordingly, the present embodiment does not mean serial connection suitable for constant current driving, and mainly focuses on a counter measure for cases where a main driving connection line is cut.

### 5. Conclusion

As described above, according to each embodiment of the present invention, a power supplying system in which a random number of current loads and a current power source are connected in series can connect and disconnect loads using connectors, and has the connectors which can connect and disconnect the loads without cutting an entire current loop. Consequently, it is possible to connect and disconnect loads without cutting a current loop when the loads are connected and disconnected.

A pair of a connector and a plug used to supply power involve three stages of states where, when the plug is not connected, electrodes inside the connector are short-circuited and, when the plug is connected, both ends of the plug and the connector electrodes are first connected and short-circuiting of the connector is then released. By this means, in a power supplying system in which random number of current loads and a current power source are connected in series, it is possible to connect and disconnect loads without cutting a current loop when the loads are connected or disconnected.

Further, in a power supplying system in which random numbers of current loads and a current power source are connected in series, loads and a power source have communication means superimposed on a power supply loop, so that it is possible to determine a state of the system based on this communication between the loads and power sources.

The preferred embodiments of the present invention have been described above with reference to the accompanying drawings, whilst the present invention is not limited to the above examples, of course. A person skilled in the art may find various alternations and modifications within the scope of the appended claims, and it should be understood that they will naturally come under the technical scope of the present invention.

### REFERENCE SIGNS LIST

1 Power feeding system
10 Current source
Connector
21a, 21b Electrode
30 Current load
100 Plug
101a, 101b Electrode

1. A connector comprising:
a connecting portion which is provided in series with respect to a current source, and to which a plug is detachably connected,
wherein the connecting portion includes a first terminal and a second terminal which are connected with a conducting wire in which a current from the current source flows, which, when the plug is not connected to the connecting portion, contact each other to short-circuit the current from the current source, for which, when the plug is connected to the connecting portion, contact therebetween is released to flow the current from the current source to the plug, and which contact each other again when connection of the plug to the connecting portion is released to short-circuit the current from the current source.

2. The connector according to claim 1, further comprising:
a contact portion which prevents the plug from being detached when the plug is connected to the connecting portion, and which makes the first terminal and the second terminal contact when connection of the plug to the connecting portion is released.

3. The connector according to claim 1, wherein a plurality of pairs of the first terminal and the second terminal oriented differently with respect to the plug are provided.

4. The connector according to claim 1, wherein a plurality of pairs of the first terminal and the second terminal having different lengths are provided.

5. The connector according to claim 1, wherein a direct current is supplied from the current source.

6. A power feeding system comprising:
a current source which flows a current;
a power receiving device which receives a supply of a current from the current source; and
a connector which supplies the current from the current source to the power receiving device to which the connector is connected,
wherein the power receiving device connects a plug to the connector to receive a supply of the current from the current source,
the connector includes a connecting portion to which the plug is detachably connected, and
the connecting portion includes a first terminal and a second terminal which are connected with a conducting wire in which a current from the current source flows, which, when the plug is not connected to the connecting portion, contact each other to short-circuit the current from the current source, for which, when the plug is connected to the connecting portion, contact therebetween is released to flow the current from the current source to the plug and then to the power receiving device, and which contact each other again when connection of the plug to the connecting portion is released to short-circuit the current from the current source.

7. The power feeding system according to claim 6, wherein the power receiving device and the current source transmit and receive information to and from each other using the conducting wire.

8. The power feeding system according to claim 6, wherein a direct current is supplied from the current source.

9. The power feeding system according to claim 6, further comprising:
a detachable current source which, when the current from the current source is supplied, connects to the connector to supplement a current,
wherein the detachable current source executes a switching operation of changing a voltage which is zero at a point of time when the detachable current source connects to the connector, to a predetermined voltage after a predetermined time passes after the connection.
